(19) United States
(12) Patent Application Publication
(10) Pub. No.: US 2019/0255928 A1
(43) Pub. Date: Aug. 22, 2019

(54) TRACTION BATTERY

(71) Applicant: MAGNA STEYR Fahrzeugtechnik AG & Co KG, Graz (AT)

(72) Inventor: Manuel ERLACHER, Radenthein (AT)

(21) Appl. No.: 16/256,011

(22) Filed: Jan. 24, 2019

(30) Foreign Application Priority Data
Feb. 20, 2018 (EP) 18157595.2

(51) Int. Cl. B60K 1/04; B60L 50/64; B60L 50/60; H01M 2/10

(52) U.S. Cl. CPC B60K 1/04; B60L 50/64; B60L 50/66; H01M 2220/20; H01M 2/1083; B60K 2001/0405; H01M 2/1077

(57) ABSTRACT

A drive battery for a motor vehicle. The drive battery includes a battery housing that is rotatable about a vertical axis with respect to the motor vehicle, a plurality of battery modules in the battery housing, a drive battery connection for the drive battery, and a plurality of cross beams in the battery housing to reinforce the drive battery at a transverse direction of the motor vehicle. The cross beams are arranged in a symmetrical manner such that with rotation of the battery housing by 180 degrees about the vertical axis, the cross beams are to lie in a same position in a longitudinal direction of the motor vehicle as prior to the rotation.

### CROSS-REFERENCE TO RELATED APPLICATIONS

The present application claims priority under 35 U.S.C. § 119 to European Patent Publication No. EP 18157595.2 (filed on Feb. 20, 2018), which is hereby incorporated by reference in its complete entirety.

### TECHNICAL FIELD

Embodiments relate to a drive battery for a motor vehicle, and to a group of motor vehicles, and to a method for producing the motor vehicle. The group of motor vehicles comprises at least a first motor vehicle and at least a second motor vehicle, the first motor vehicle and the second motor vehicle each comprises such a drive battery.

### BACKGROUND

Drive batteries for motor vehicles have been known for some time and are installed in electrically driven vehicles, such as electric and hybrid electric vehicles. Drive batteries of this type are configured for higher energy outputs and are therefore formed by so-called “high voltage batteries.” Such drive batteries usually comprise a greater number of battery modules that are connected to one another and are able to output the required high voltage at a common electrical connection of the drive battery.

Such drive batteries usually require a relatively large installation space and are by way of example installed as flat batteries in the region of a subfloor of a motor vehicle. In order to increase safety, in particular, in the event of a motor vehicle accident, it is known to arrange reinforcing structures around drive batteries in a vehicle or also within the drive batteries themselves.

Motor vehicles are nowadays also frequently marketed in different equipment variants and, in particular, with different drive variants on a common vehicle platform. Thus, a specific vehicle type may be marketed, by way of example, with a front-wheel drive and a rear-wheel drive. It is usually necessary for different drive variants to install different drive batteries and/or to route additional electrical lines or rather heating or cooling lines in order to reach a drive from the position of an electrical connection or heating/cooling connection of the drive battery. It is necessary to perform new calculations with regard to vehicle safety for each drive arrangement and in particular for each position of the reinforcing structures of the motor vehicle.

### SUMMARY

Embodiments relate to a drive battery for a motor vehicle, a group of motor vehicles, and a method for producing such a motor vehicle. The group of motor vehicles may comprises at least a first motor vehicle having a first drive battery, and a second motor vehicle having a second drive battery, wherein the first drive battery and the second drive battery are respectively configured in an optimum manner for different drive variants, and new calculations with regard to vehicle safety are not required.

In accordance with embodiments, a drive battery for a motor vehicle may comprise: a battery housing; a plurality of battery modules in the battery housing; a connection for the drive battery; and at least one cross beam in the battery housing to reinforce the drive battery in an installation position at a transverse direction of the vehicle, the cross beams being arranged in a symmetrical manner with respect to a rotation of the drive battery by 180 degrees about a vertical axis, wherein after the rotation of the drive battery, the cross beams are to lie in the same position in the longitudinal direction of the vehicle as prior to the rotation.

In accordance with embodiments, a drive battery for a motor vehicle may comprise: a battery housing; a plurality of battery modules in the battery housing; a connection for the drive battery; and a plurality of cross beams in the battery housing to reinforce the drive battery in an installation position at a transverse direction of the vehicle, the cross beams being arranged in a symmetrical manner with respect to a rotation of the drive battery by 180 degrees about a vertical axis, wherein after the rotation of the drive battery, the cross beams are to lie in the same position in the longitudinal direction of the vehicle as prior to the rotation.

In accordance with the invention, a drive battery may comprise: a battery housing having at least one cross beam to provide reinforcement, which when viewed in an installation position of the drive battery, extend in a transverse direction of the vehicle.

In accordance with the invention, a drive battery may comprise: a battery housing having at least two cross beams to provide reinforcement, which when viewed in an installation position of the drive battery, extend in a transverse direction of the vehicle.

In accordance with the invention, a drive battery may comprise: a battery housing having a plurality of cross beams to provide reinforcement, which when viewed in an installation position of the drive battery, extend in a transverse direction of the vehicle.

In accordance with embodiments, the drive battery in the plan view has essentially a rectangular shape, by way of example a square shape, and that the cross beams extend parallel to the shorter side of the rectangle, from one longitudinal side to the opposite-lying longitudinal side of the rectangle.

In accordance with embodiments, the cross beams are arranged in the battery such that, after a rotation of the drive battery by 180 degrees about a vertical axis, (i.e., after a rotation of a side of the drive battery that lies towards the front, rearwards and conversely) the cross beams come to lie in the same position in the longitudinal direction of the vehicle as prior to the rotation. In this case, it is naturally not necessary for each individual cross beam to come to lie back in the same position as prior to the rotation, but rather, for most of the cross beams, a different cross beam comes to lie in the position in the longitudinal direction of the vehicle in which the cross beam was located prior to the rotation. Only one cross beam that is arranged centrally in the longitudinal direction comes to lie itself in the same position in the longitudinal direction after the rotation.

In accordance with embodiments, in the event that a drive battery comprises only one cross beam, the cross beam therefore lies centrally in the longitudinal direction.

In accordance with embodiments, a drive battery may comprise a plurality of cross beams arranged in each case at equal distances to both sides from the middle of the battery housing in the longitudinal direction of the vehicle. By virtue of arranging the cross beams of the drive battery in this manner, it is possible to use the same drive battery in a vehicle having a rear-wheel drive and in a vehicle having a front-wheel drive, and therefore, the identical component may be produced in a greater quantity.

In accordance with embodiments, in a vehicle having a rear-wheel drive, it is possible to arrange the battery rotated by 180 degrees in comparison to a vehicle having a front-wheel drive with the result that the connection of the battery, in particular, an electric connection, and/or a heating connection, and/or a cooling connection comes to lie in both drive variants only a short distance from the drive of the vehicle and only short connecting lines are required. Since in this case the cross beams of the drive battery in both drive variants come to lie in the same positions, it is not necessary to perform a new calculation of the characteristics, in particular, of the manner in which the load-bearing reinforcing structures will behave in an accident.

In accordance with embodiments, all cross beams are arranged at uniform intervals in the battery housing in the longitudinal direction of the vehicle.

In accordance with embodiments, the drive battery may further comprise at least one longitudinal beam in the battery housing so as to reinforce the drive battery in an installation position in a longitudinal direction of the vehicle, wherein each longitudinal beam is arranged in a symmetrical manner with respect to a rotation of the drive battery by 180 degrees about a vertical axis such that, after the rotation of the drive battery, the longitudinal beams come to lie in the same positions in the transverse direction of the vehicle as prior to the rotation. In a similar manner to the cross beams, each longitudinal beam may also therefore be arranged in the battery housing in such a manner that the reinforcing characteristics do not change in the case of the battery being rotated by 180 degrees.

In accordance with embodiments, the drive battery may further comprise a plurality of longitudinal beams in the battery housing so as to reinforce the drive battery in an installation position in a longitudinal direction of the vehicle, wherein each longitudinal beam is arranged in a symmetrical manner with respect to a rotation of the drive battery by 180 degrees about a vertical axis such that, after the rotation of the drive battery, the longitudinal beams come to lie in the same positions in the transverse direction of the vehicle as prior to the rotation. In a similar manner to the cross beams, each longitudinal beam may also therefore be arranged in the battery housing in such a manner that the reinforcing characteristics do not change in the case of the battery being rotated by 180 degrees.

In accordance with embodiments, the longitudinal beams are arranged at uniform intervals in the battery housing in the transverse direction of the vehicle.

In accordance with embodiments, the cross beams and the longitudinal beams collectively form a uniform, right-angled grid, on the one hand, at equal distances with respect to one another in the longitudinal direction of the vehicle, and on the other hand, at equal distances with respect to one another in the transverse direction of the vehicle.

In accordance with embodiments, a connection, such as, for example, an electrical connection, is arranged on an end face of the battery housing. In addition, a cooling connection is arranged on the same end face of the battery housing as the electrical connection. By virtue of the battery being rotated by 180 degrees, the respective electrical connection and the cooling connection thereby come to lie close to the front end or the rear end of the vehicle.

In accordance with embodiments, the battery modules are arranged between the cross beams, and where appropriate, between the longitudinal beams.

In accordance with embodiments, a group of motor vehicles may comprise at least a first motor vehicle having a front-wheel drive and a first drive battery (e.g., of the type described herein), and at least a second motor vehicle having a rear-wheel drive and a second drive battery (e.g., of the type described herein), wherein the second drive battery is rotatable by 180 degrees about a vertical axis in comparison to the arrangement of the first drive battery such that the cross beams in the second motor vehicle may lie in the same positions in the longitudinal direction of the vehicle as the cross beams the first motor vehicle.

In accordance with embodiments, the first motor vehicle having a front-wheel drive has a connection (e.g., an electrical connection and/or a heating connection and/or cooling connection) of the first drive battery arranged closer to the front of the vehicle, such as, for example, on a front face wall of the battery housing. The second motor vehicle having a rear-wheel drive has a connection (e.g., an electrical connection and/or a heating connection and/or cooling connection) of the second drive battery arranged closer to the rear of the vehicle, such as, for example, on a rear face wall of the battery housing. Accordingly, each connection of the drive battery is arranged close to the drive.

In accordance with embodiments, the term “connection” is not limited to a single electrical and/or mechanical contact or just to one plug connector, but rather, may comprise one or two connector plugs or terminal clamps for the two battery terminals and/or for the cooling circuit/heating circuit of the battery.

In accordance with embodiments, a method for producing a group of motor vehicles may comprise: equipping a first motor vehicle in the group with a front-wheel drive, and equipping a second motor vehicle in the group with a rear-wheel drive; equipping the first motor vehicle with a first drive battery (e.g., of the type described herein) and equipping the second motor vehicle with a second drive battery (e.g., of the type described herein), as previously described, wherein the second drive battery is rotatable by 180 degrees about a vertical axis in comparison to the first drive battery such that the cross beams of the second motor vehicle lie in the same position in the longitudinal direction of the vehicle as the cross beams of the first motor vehicle.

In accordance with embodiments, a method for producing motor vehicles therefore includes a rotatable drive battery, irrespective as to whether a motor vehicle is configured with a front-wheel or a rear-wheel drive, or not prior to the installation.

In accordance with embodiments, a similar drive battery is installed in a vehicle having a rear-wheel drive and in a vehicle having a front-wheel drive. In the vehicle having a rear-wheel drive, the battery is arranged for rotation by 180 degrees in comparison to a vehicle having a front-wheel drive such that a connection (e.g., an electrical connection and/or a heating connection and/or cooling connection) of the battery, is arranged close to the drive of the vehicle in both motor vehicles despite different positions of the drives in the vehicle.

In accordance with embodiments, a drive battery having the features as previously described herein may also be used in the motor vehicle production, wherein the drive battery is rotatable by 180 degrees or not depending upon whether said drive battery is installed in a motor vehicle having a rear-wheel drive or in a motor vehicle having a front-wheel drive.

### DRAWINGS

Embodiments will be illustrated by way of example in the drawings and explained in the description below.

FIG. 1 illustrates a schematic sectional view of a group of motor vehicles, in accordance with embodiments.

FIG. 2A illustrates top, front, and side views of a drive battery having a battery cover, in accordance with embodiments.

FIG. 2B illustrates a three-dimensional view of the drive battery of FIG. 2A.

FIG. 3A illustrates top, front, and side views of a drive battery without a battery cover, in accordance with embodiments.

FIG. 3B illustrates a three-dimensional view of the drive battery of FIG. 3A.

FIG. 4 illustrates a top view of the drive battery of FIG. 3A, with load paths drawn in over the cross beams (upper illustration) and over the longitudinal beams (lower illustration).

FIG. 5 illustrates a bottom schematic view of the drive battery of FIG. 3A, in an installation position in a vehicle having a front-wheel drive (upper illustration) and in a vehicle having a rear-wheel drive (lower illustration).

### DESCRIPTION

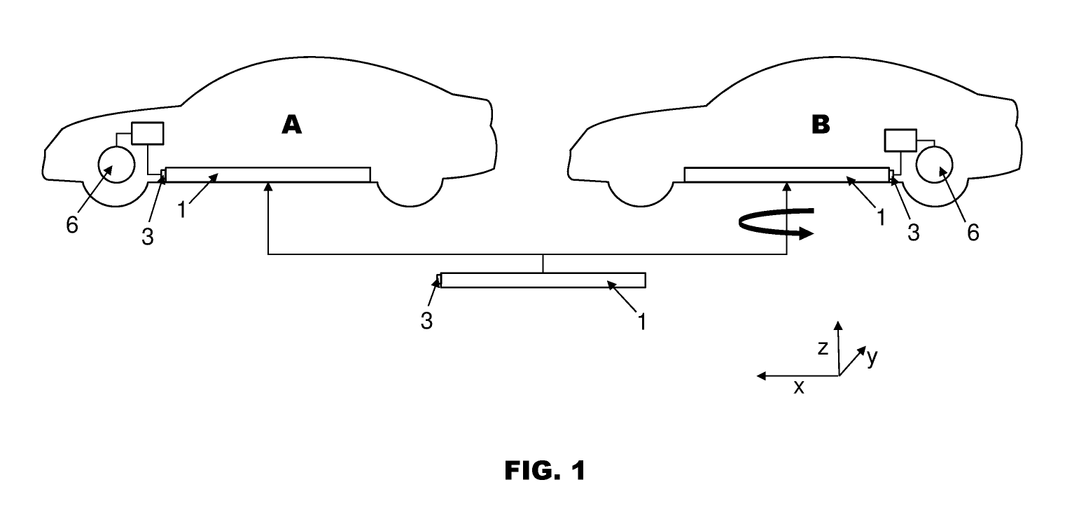

FIG. 1 illustrates a drive battery in a first motor vehicle A having a front-wheel drive and in a second motor vehicle B having a rear-wheel drive. The vehicle coordinate system used herein has a longitudinal direction x, transverse direction y, and vertical direction z.

The first motor vehicle A and the second motor vehicle B respectively include a drive battery comprising a battery housing 1, and is configured as a flat storage device having a rectangular base cross-section. The drive battery housing 1 is arranged in the region of a subfloor of each respective motor vehicle A, B. The drive battery comprises on an end face at least one connection 3 such as, for example, an electrical connection, and/or a heating connection (to a heating system of the motor vehicle A, B), and/or a cooling connection (to a cooling system of the motor vehicle A, B). The electrical connection, and/or the heating connection, and/or the cooling connection may be arranged adjacent to or combined with each other. In the example of an electrical connection, the connection 3 comprises a positive connection terminal and a negative connection terminal of the drive battery.

The first motor vehicle A having a front-wheel drive also comprises an electric drive motor 6 arranged at the front of the first motor vehicle A. In this instance, the connection 3 of the drive battery is arranged on an end face of the battery housing 1 so as to face adjacent to the electric drive motor 6. In this way, only a short length of connecting line(s) is required between the drive battery and the drive motor 6.

The second motor vehicle B having a rear-wheel drive also comprises an electrical drive motor 6 arranged in the rear of the second motor vehicle B. For this purpose, the drive battery is rotatable by 180 degrees about a vertical axis in comparison to the installation position in the first motor vehicle A having a front-wheel drive. In this way, the electrical connection 3 of the drive battery for the second motor vehicle B is arranged on the rear end face of the battery housing 1 and only a short length of connecting line(s) is required.

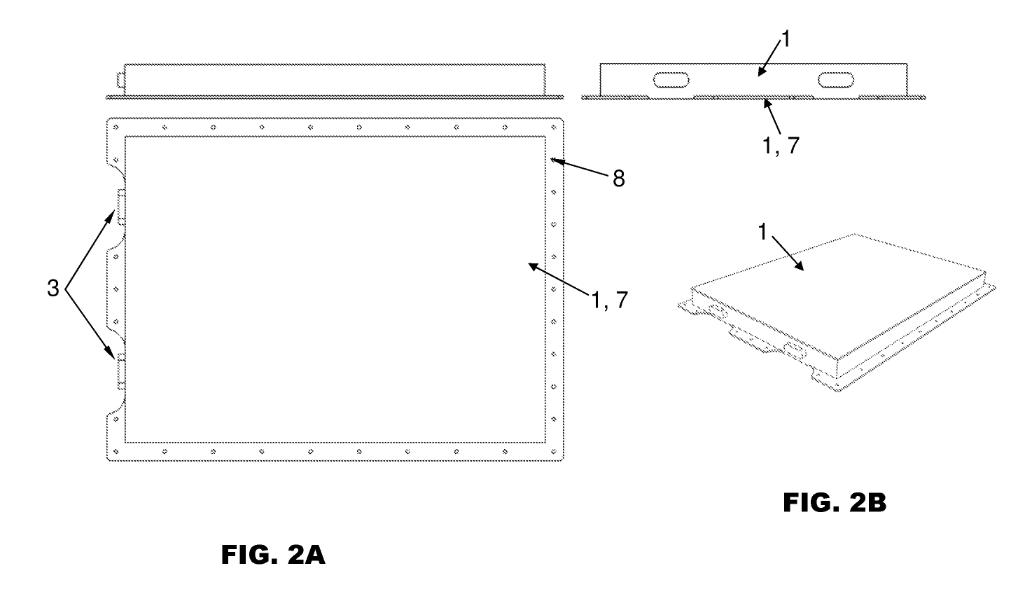

As is illustrated FIGS. 2 to 5, the drive battery further comprises a plurality of cross beams 4 and a plurality of longitudinal beams 5 in the battery housing 1 to reinforce the drive battery in an installation position in the transverse direction y of the vehicle or rather in the longitudinal direction x of the vehicle.

In accordance with embodiments, the cross beams 4 are arranged in a symmetrical manner with respect to a rotation of the drive battery by 180 degrees about the axis z, such that, after such rotation of the drive battery, the cross beams 4 come to lie in the same positions in the longitudinal direction x of the vehicle as prior to the rotation.

In accordance with embodiments, the longitudinal beams 5 are arranged in a symmetrical manner with respect to a rotation of the drive battery by 180 degrees about the axis z, such that, after such rotation of the drive battery, the longitudinal beams 5 come to lie in the same positions in the transverse direction y of the vehicle as prior to the rotation.

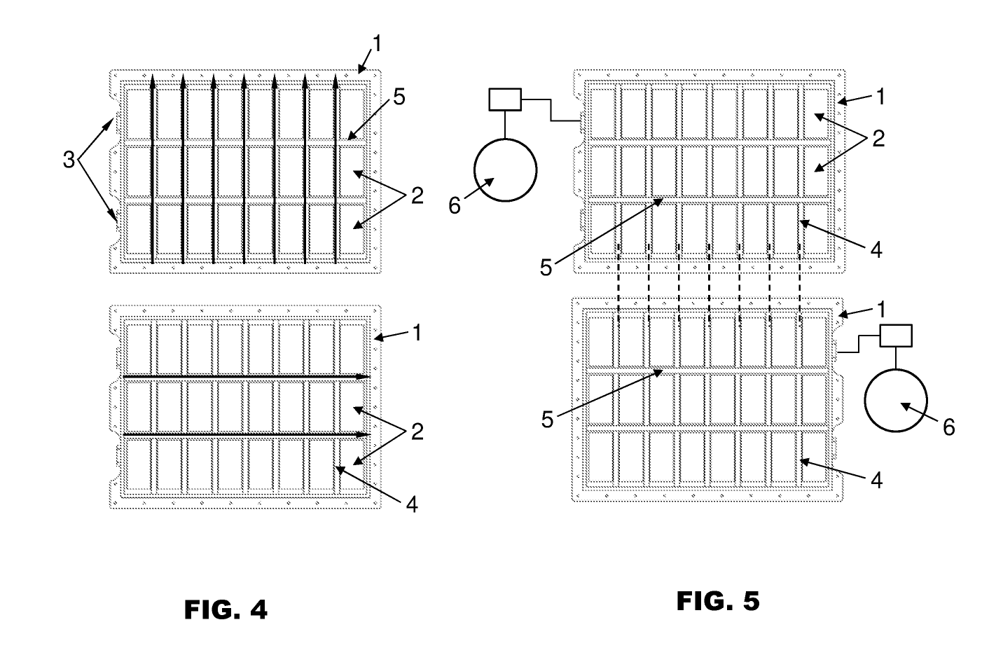

Accordingly, in the case of such a drive battery being installed in the two positions that are rotated with respect to one another and are illustrated in FIG. 1 on the left-hand side or rather on the right-hand side, the positions of the transverse beams 4 and also of the longitudinal beams 5 remain unchanged. The load paths on the cross beams 4 and on the longitudinal beams 5, drawn in as arrows in FIG. 4, remain unchanged (see, FIG. 5). The same drive battery may be used in both vehicle variants without having to perform a new calculation of the mechanical characteristics of the reinforcing structures, in particular, of the manner in which the reinforcing structures of the drive battery behave in an accident.

In accordance with embodiments, the cross beams 4 and the longitudinal beams 5 collectively form an approximately uniform or uniform right-angled grid. The grid is formed by the cross beams 4 being arranged spaced apart at approximately equal or equal distances with respect to one another in the longitudinal direction x of the vehicle, and the longitudinal beams 5 being arranged at approximately equal or rather equal distances with respect to one another in the transverse direction y of the vehicle. Likewise, the cross beams 4 are arranged spaced apart in a symmetrical manner with respect to the middle of the drive battery in the longitudinal direction with the result that the cross beams on the left-hand side and right-hand side of the central axis are each an equal distance away from the central axis. The longitudinal beams are arranged in a similar symmetrical manner with respect to the middle of the drive battery in the transverse direction. The longitudinal beams are therefore on both sides of the horizontally illustrated central axis in the longitudinal direction in each case an equal distance from said central axis.

FIGS. 2A and 2B illustrate such a drive battery having with a battery cover 7 placed in position thereon, in accordance with embodiments. The battery cover 7 is part of the battery housing 1 and is removable by way of example from above or below.

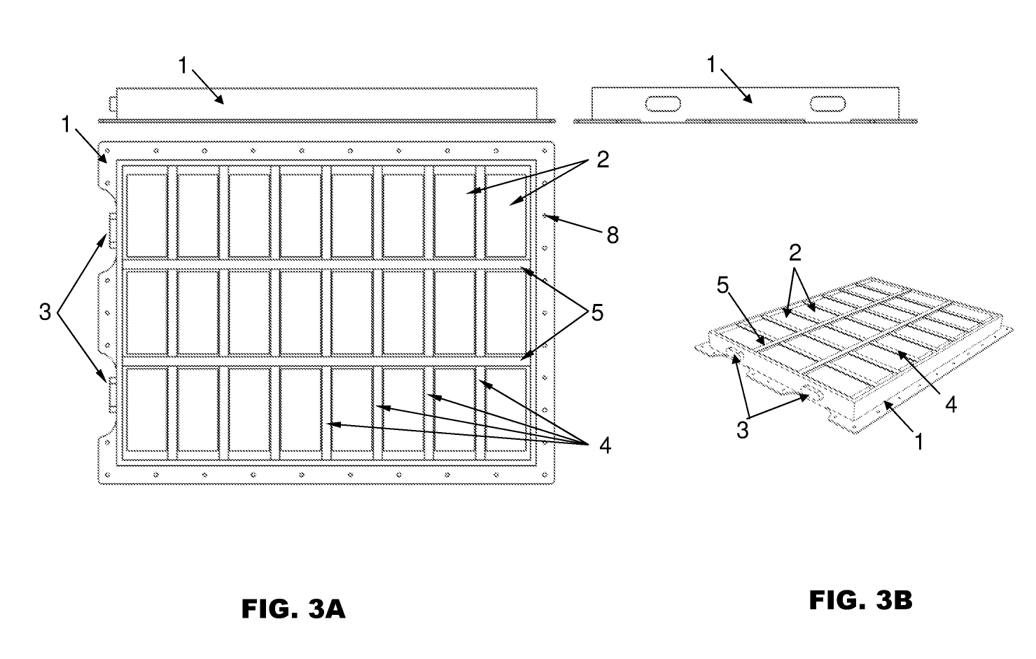

FIGS. 3A and 3B illustrate the drive battery of FIGS. 2A and 2B, but with the battery cover 7 being removed, i.e., the battery cover 7 has been removed or hidden from view.

In accordance with embodiments, the battery housing 1 comprises a flange area having a plurality of mechanical connection points 8 for attaching (e.g., via screw connection) to the shell of the motor vehicle A, B.

The example of a connection 3 as an electrical connection is arranged on an end face of the battery housing 1, by way of example, in the form of one or two connector plugs or terminal clamps for the battery terminals.

In accordance with embodiments, additionally or alternatively, it is also possible to arrange another connection 3 as a cooling connection for a cooling system, in particular, for a cooling circuit of the battery close to the electrical connection and/or on the end face of the battery housing 1, also in the event that the battery housing 1 does not comprise an electrical connection because the energy is transmitted, by way of example, in an inductive manner.

In accordance with embodiments, additionally or alternatively, it is also possible to arrange the connection 3 as a cooling connection for a cooling system, in particular, for a heating circuit of the battery close to the electrical connection 3 and/or on the end face of the battery housing 1, also in the event that said battery housing does not comprise an electrical connection because the energy is transmitted by way of example in an inductive manner.

In accordance with embodiments, the battery modules 2 may be arranged in intermediate spaces between the cross beams 4 and between the longitudinal beams 5. The battery modules 2, cross beams 4, and longitudinal beams 5 may, for example, be arranged at the same vertical height.

FIG. 4 illustrates the drive battery of FIG. 3A, in which load paths are drawn over the cross beams 4 as arrows (in the upper illustration), and load paths are drawn over the longitudinal beams 5 on the same drive battery (in the lower illustration). The motor vehicles A, B in which the illustrated drive batteries are accommodated likewise comprises reinforcing structures, such as, for example, cross beams 4 and longitudinal beams 5. For example, at the ends of the cross beams 4 and/or longitudinal beams 5, i.e., at the positions of the cross beams 4 or the longitudinal beams 5 that remain unchanged in the case of a rotation by 180 degrees, such that the illustrated load paths continue to be guided in a purposeful manner in the motor vehicle A, B in order to absorb or dissipate the forces that occur.

FIG. 5 illustrates the drive battery of FIG. 3A in the installation position in a motor vehicle A, B having a front-wheel drive (in the upper illustration), and in a vehicle having a rear-wheel drive (in the lower illustration). By virtue of the symmetrical uniform distribution of the cross beams 4, the same positions for the cross beams 4 are achieved (illustrated by broken lines), as the drive battery is rotated according to the respective drive concept (i.e., front wheel drive or rear wheel drive), and it is consequently achieved that vehicles having different drive concepts (front-wheel drive, rear-wheel drive or 4-wheel drive) demonstrate the same behavior in the event of a side-on crash.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 Battery housing
2 Battery module
3 Connection (electrical/heating/cooling)
4 Cross beam
5 Longitudinal beam
6 Drive motor
7 Battery cover
8 Screwing point
A First motor vehicle
B Second motor vehicle
x Longitudinal direction of the vehicle
y Transverse direction of the vehicle
z Vertical axis

What is claimed is:

1. A drive battery for a motor vehicle, the drive battery comprising:
a battery housing that is rotatable about a vertical axis with respect to the motor vehicle;
a plurality of battery modules in the battery housing;
a drive battery connection for the drive battery; and
a plurality of cross beams in the battery housing to reinforce the drive battery, in an installation position of the drive battery, at a transverse direction of the motor vehicle, the cross beams being arranged in a symmetrical manner such that with rotation of the battery housing by 180 degrees about the vertical axis, the cross beams are to lie in a same position in a longitudinal direction of the motor vehicle as prior to the rotation.

2. The drive battery of claim 1, wherein the cross beams are arranged in the battery housing at uniform intervals in the longitudinal direction of the motor vehicle.

3. The drive battery of claim 1, further comprising a plurality of longitudinal beams in the battery housing to reinforce the drive battery, in the installation position of the drive battery, in the longitudinal direction of the motor vehicle, the longitudinal beams being arranged in a symmetrical manner such that with rotation of the battery housing by 180 degrees about the vertical axis, the longitudinal beams are to lie in a same position in a transverse direction of the motor vehicle as prior to the rotation

4. The drive battery of claim 3, wherein the longitudinal beams are arranged in the battery housing at uniform intervals in the transverse direction of the motor vehicle.

5. The drive battery of claim 3, wherein the cross beams and the longitudinal beams collectively form a uniform, right-angled grid at equal distances with respect to one another in the longitudinal direction and the transverse direction of the motor vehicle.

6. The drive battery of claim 1, wherein the drive battery connection comprises an electrical connection arranged on an end face of the battery housing.

7. The drive battery of claim 6, wherein the drive battery connection comprises a cooling connection arranged on a same end face of the battery housing as the electrical connection.

8. The drive battery of claim 1, wherein the drive battery connection comprises an electrical connection arranged on an end face of the battery housing.

9. The drive battery of claim 1, wherein the battery modules are arranged in intermediate spaces between the cross beams and the longitudinal beams.

10. The drive battery of claim 1, wherein the cross beams and the longitudinal beams define intermediate spaces configured to receive the battery modules.

11. A group of motor vehicles, comprising:
at least a first motor vehicle having a front-wheel drive and a first drive battery that includes a first battery housing that is rotatable about a vertical axis with respect to the first motor vehicle, a plurality of first battery modules in the first battery housing, a first connection for the first drive battery, and a plurality of first cross beams in the first battery housing to reinforce the first drive battery, in an installation position of the first drive battery, at a transverse direction of the first motor vehicle; and
at least a second motor vehicle having a rear-wheel drive and a second drive battery that includes a second battery housing that is rotatable about a vertical axis with respect to the arrangement of the first drive battery, a plurality of second battery modules in the second battery housing, a second connection for the second drive battery, and a plurality of second cross beams in the second battery housing to reinforce the second drive battery, in an installation position of the second drive battery, at a transverse direction of the second motor vehicle, the second cross beams being arranged in a symmetrical manner such that with rotation of the second battery housing by 180 degrees about the vertical axis, the second cross beams are to lie in a same position in a longitudinal direction of the first motor vehicle.

12. A method for producing a motor vehicle, the method comprising:
arranging, in an installation position in the motor vehicle, a drive battery having a battery housing, a plurality of battery modules in the battery housing, a drive battery connection and a plurality of cross beams to reinforce the drive battery at a transverse direction of the motor vehicle, such that the battery housing is rotatable about a vertical axis with respect to the motor vehicle; and
arranging the cross beams in the battery housing in a symmetrical manner such that with rotation of the battery housing by 180 degrees about the vertical axis, the cross beams are to lie in a same position in a longitudinal direction of the motor vehicle as prior to the rotation.

13. The method of claim 12, wherein arranging the cross beams comprises arranging the cross beams in the battery housing at uniform intervals in the longitudinal direction of the motor vehicle.

14. The method of claim 12, wherein the drive battery further includes a plurality of longitudinal beams to reinforce the drive battery in the longitudinal direction of the motor vehicle.

15. The method of claim 14, further comprising arranging the longitudinal beams in the battery housing in a symmetrical manner such that with rotation of the battery housing by 180 degrees about the vertical axis, the longitudinal beams are to lie in a same position in a transverse direction of the motor vehicle as prior to the rotation.

16. The method of claim 15, wherein arranging the longitudinal beams comprises arranging the longitudinal beams in the battery housing at uniform intervals in the transverse direction of the motor vehicle.

17. The method of claim 12, wherein the drive battery connection comprises an electrical connection arranged on an end face of the battery housing.

18. The method of claim 17, wherein the drive battery connection comprises a cooling connection arranged on a same end face of the battery housing as the electrical connection.

19. The method of claim 12, further comprising arranging the battery modules in intermediate spaces defined by the cross beams and the longitudinal beams.

20. The method of claim 12, further comprising arranging the battery modules in intermediate spaces in a uniform, right-angled grid formed by the cross beams and the longitudinal beams.
